(19) United States
(12) Patent Application Publication
(10) Pub. No.: US 2003/0176636 A1
(43) Pub. Date: Sep. 18, 2003

(54) Method and device for removing volatile components from polymer materials

(76) Inventors: Ulrich Liesenfelder, Bergisch Gladbach (DE); Martin Ullrich, Leverkusen (DE); Ralph Ostarek, Valls (ES); Richard Weider, Leverkusen (DE); Jurgen Kuckla, Koln (DE); Gisbert Michels, Leverkusen (DE)

Correspondence Address: Norris McLaughling & Marcus, 30th Floor, 220 East 42nd Street, New York, NY, 10017, US

(21) Appl. No.: 10/240,627

(22) PCT Filed: Mar. 23, 2001
(86) PCT No.: PCT/EP01/03333

(30) Foreign Application Priority Data
Apr. 5, 2000 (DE) 100 16 894.9

(51) Int. Cl. B01D 3/28

(52) U.S. Cl. 528/501; 159/2.1; 159/2.3; 159/49; 159/43.1; 159/DIG. 8; 159/DIG. 20

(57) ABSTRACT

A description is given of a process and an apparatus for the removal of volatile constituents, in particular solvents, monomers or oligomers, from polymer compositions or polymer solutions by evaporating the volatile components from the preheated polymer compositions in the form off free-falling films, strands (4) or foaming liquids in an evaporator system (1). In the process, following partial or complete degassing of the volatile components in the degassing space (9) of the evaporator system (1), the degassed polymer composition (4) is received at the lower end of the evaporator system (1) directly by a discharge delivery device (5) and is discharged, thereby avoiding contact of the polymer with the inside wall of the evaporator system (1).

The invention relates to a process and apparatus for the removal of volatile constituents, in particular solvents, monomers or oligomers, from polymer compositions or polymer solutions by evaporating the volatile components from the preheated polymer compositions in the form off free-falling films, strands or foaming liquids in an evaporator system. In the process, following partial or complete degassing of the volatile components in the degassing space of the evaporator system, the degassed polymer composition is received at the lower end of the evaporator system directly by a discharge delivery device and is discharged, thereby avoiding contact of the polymer with the inside wall of the evaporator system.

Numerous processes for isolating polymers from solution are known from the literature. These are on the one hand machine-based processes, i.e. those processes in which the degassing operation takes place in the process space of a machine, and on the other hand apparatus-based processes, where the actual degassing operation takes place in static apparatuses.

Apparatus-based processes, of which the process according to the invention is one, generally entail lower costs than machine-based processes. They are therefore frequently used.

Mention should be made firstly of the class comprising falling-film apparatuses, which may be considered as predecessors of the thin-film evaporators, and are restricted in use to the lower to moderate viscosity range.

Most apparatus-based evaporating processes work with a combination of a heat exchanger with heated surfaces over which the energy necessary for the evaporation is fed to the polymer or the polymer solution, a degassing chamber, where a phase separation takes place under the force of gravity, and a discharge pump, which discharges the polymer from a melt sump at the bottom of the degassing vessel. In this case, it is possible to process all products which are able to flow to the discharge pump under the force of gravity. Special designing of the pump and the transition between the degassing vessel and the pump makes it possible to process polymers with a viscosity of up to 20,000 Pa*s. Highly elastic polymers and non-flowable polymers cannot be processed with the known apparatuses.

To lessen the thermal loading of the polymer, it is advisable to instigate the evaporation of volatile constituents at the same time as energy is being supplied, as is described in patent specifications U.S. Pat. Nos. 3,853,672 and 4,537,954. However, in specific cases, this two-phase mode of operation of the heat exchanger leads to stability problems, with the result that it may be necessary to keep the heat exchanger in single-phase operation by maintaining pressure.

Numerous devices which are intended to improve the residence time of the product in the degassing chamber, and consequently the degassing, are described in the patent literature.

According to the prior-art processes, the concentrated polymer melt is collected at the bottom of the degassing chamber in a sump and discharged through a discharge member, generally a gear pump.

There is no longer any appreciable degassing of the polymer in the sump, since the mass transfer by diffusion and the rising rate of bubbles in the highly viscous melt are very slow and the free surface is continuously covered over with replenishing polymer melt. The patent specification U.S. Pat. No. 4,954,303 describes a special agitating mechanism which keeps the sump of polymer in circulation in order to improve the mass transfer from the sump.

In the case of sensitive products, thermal degradation of the polymer takes place in this melt sump when there are residence times of up to half an hour. Furthermore, there is the risk of the polymer being contaminated on contact with highly degraded constituents adhering to the wall.

Machine-based processes for polymer degassing with the aid of screw conveyors have a wider operative range than the said apparatus-based processes. In particular, degassing on screw machines is significant. The relevant prior art is presented by Hans Wobbe: “Schneckenmaschinen für das Entgasen von Kunststoffen” [screw machines for the degassing of plastics] in “Entgasen beim Aufbereiten von Kunststoffen” [degassing in the compounding of plastics”, VDI-Verlag 1992. The advantage of screw machines, in particular twin-shaft screw machines is that they are universally suitable for use with products of complicated rheology.

However, apart from the high costs and complex apparatus required, the high shear loading to which the product is subjected in screw conveyors is disadvantageous. In the case of styrene-acrylonitrile copolymers as an example of thermally sensitive polymers, the increasing temperature brought about by the shearing energy leads to depolymerization and discoloration from a temperature of 280° C. The two-phase acrylonitrile-butadiene-styrene terpolymers (ABS) are an example of shearing sensitivity. If the evaporation of an ABS solution is carried out on a screw machine, the morphology of the two-phase system is changed by the high shearing load. It is consequently not possible for property profiles to be specifically set on the basis of the phase morphology.

Finally, mention should be made of the evaporation of polymer solutions on thin-film evaporators. They represent a further development of the falling-film and thin-film apparatuses with an extended operative range. However, the upper viscosity limit for processing on thin-film evaporators is around 10,000 Pa*s.

It is an object of the invention to provide a process and apparatus for the removal of volatile constituents from polymers or polymer solutions which avoid the discussed disadvantages of known processes and are simple in terms of apparatus requirements.

The invention concerns a process for the removal of volatile constituents, in particular solvents, monomers or oligomers, from polymer compositions or polymer solutions by evaporating the volatile constituents from the preheated polymer compositions in the form of free-falling films, strands or foaming liquids in an evaporator system, characterized in that, following the partial or complete degassing of the volatile components in the degassing space of the evaporator system, the degassed polymer composition is received at the lower end of the evaporator system directly by a discharge delivery device and is discharged, thereby avoiding contact of the polymer with the inside wall of the evaporator system.

The polymer solution is, for example, initially supplied with the enthalpy of evaporation necessary for evaporating the volatile constituents by a prior-art heat exchanger. While the heat of evaporation is being supplied via the heating surfaces or devolatizing is taking place at a pressure-maintaining valve, a two-phase mixture of concentrate solution or polymer melt and gas is produced. This mixture is fed either directly or via a distributing device to the degassing chamber, where a phase separation takes place under the force of gravity.

The polymer partially or completely separated from the gas fraction is taken up directly by the discharge member at the bottom of the degassing chamber. As a result, no contact takes place between the polymer to be isolated and fixed walls of the apparatus. The risk of contamination with degraded product adhering to uncleaned surfaces is minimal. The process according to the invention avoids product degradation and contamination by operating without a sump and is not limited with respect to the flow behaviour of the polymers to be processed.

In particular, the process according to the invention can also be used for processing products with difficult flow behaviour, that is for example those which have a high melt elasticity. Even products with a pronounced flow limit can be processed.

The term discharge delivery device is understood to mean machines which grasp the polymer strands, films or undefined or foam-like formations from a devolatizing evaporation stage, compress them and extrude them against pressure. In particular, a gear pump of the same type as polymer discharge pumps, for example the Vacorex type from the company Maag, Zurich, can be used for this. Gear pumps have the disadvantage, however, that in such a greatly under-fed mode of operation, they are not working in the range of their optimum efficiency. The dimensioning of the pump must be based on the size of the intake opening. This results in relatively large overall sizes, with correspondingly high procurement costs.

Therefore, multi-shaft screw pumps are used with preference as the discharge delivery device, for example those according to EP 92 725 B1. However, one aspect of the known discharge delivery device which may be criticised is that the construction with four shaft glands is relatively complex and that a transition from four shafts to two shafts takes place, causing a radial force to act on the shafts which can cause problems in terms of wear.

The evaporation takes place with preference in one to three evaporating stages following one after the other.

It is particularly preferred for the evaporation of the polymer composition to take place in two, three or more stages (in particular in two stages), the polymer separated completely or partially from volatile components in the degassing space being taken up directly by the discharge delivery device in every stage.

In a variant of the process, polymer compositions or solutions which assume a non-flowable state after the separation of the volatile components are processed.

Thermoplastic polymers, rubber or rubber-modified thermoplastics, in particular polycarbonate, polystyrene, polyphenylene sulphide, polyurethane, polyamide, polyester, polyacrylate, polymethylmethacrylate, SAN resin, ABS, EPDM rubber, polybutadiene or possible mixtures of the polymers can be used as polymers which are processed particularly well by the process according to the invention.

According to a preferred design, it is advantageous to admix with the polymer additional agents customary in plastics technology (additives, dyes, pigments, stabilizers etc.) directly following the degassing, in particular complete degassing, in a mixing zone.

The invention also concerns an apparatus for discharging highly viscous polymer compositions from evaporator systems, in particular strand evaporators, tube evaporators or lamellar evaporators, for the removal of volatile compounds from the polymer compositions in the form of free-falling films, strands or foams, comprising at least one single-shaft or multi-shaft, in particular twin-shaft, screw delivery device, which is arranged at the lower end of the evaporator system, characterized in that the inlet opening of the screw delivery device is arranged beneath the distributor for the polymer composition, the cross section of the inlet opening being greater than the cross section of the polymer composition flowing down.

Preferred is an apparatus which is characterized in that a twin-shaft screw delivery device is provided as the discharge device, with a drive means for the mutual rotation of the screw shafts, the screws conveying inwards in the region of the inlet opening (i.e. the polymer compositions are taken up by the screw shafts and drawn into the intermediate space between the two shafts).

It is preferred for the pitch of the screw flights of the screw shafts to be greater than or equal to the diameter of the screw shaft in the region of the inlet opening.

In a preferred variant of the apparatus, the profile of the screw shafts in the case of a twin-shaft or multi-shaft arrangement is freely intermeshing in the region of the inlet opening (also known as the capture zone) and closely intermeshing in the extrusion zone.

It is particularly preferred for screw pumps which correspond to the following description to be used as the discharge delivery device: the screw pump has two adjacent shafts, which rotate in opposite directions. In the region of the capture zone, i.e. where the polymer strands or the like are received, the otherwise closely intermeshing screw profile is replaced by a freely intermeshing profile for the sake of a better intake capacity. In the pumping zone, i.e. in the closed part of the screw, the transition from the freely intermeshing profile to the closely intermeshing profile takes place, accompanied by a reduction in volume. The rotational speed at which the machine is operated is dictated by the feeding allowance of the capture zone. In order that the pumping zone can work with optimum efficiency at this speed, the increase in pitch of the screw or, in an extreme case, the diameter of the screw is generally reduced in the pumping zone. The machine is driven by means of a simple gear mechanism.

A further preferred embodiment comprises a roll mill, which takes up the concentrated polymer and feeds it through the roll nip to a single-shaft or twin-shaft screw.

A particularly preferred form of the apparatus has at the screw delivery device a mixing zone which adjoins the inlet opening and has an additional inlet for solid material or liquid.

If appropriate, in the process according to the invention entraining agents may also be added to the polymer or the polymer solution for improving the degassing process, as described by F. A. Streiff: “Statische Entgasungsapparate” [static degassing apparatuses] in “Entgasen beim Aufbereiten von Kunststoffen”, VDI-Verlag 1992.

The invention is explained in more detail below by way of example with reference to the figures, in which:

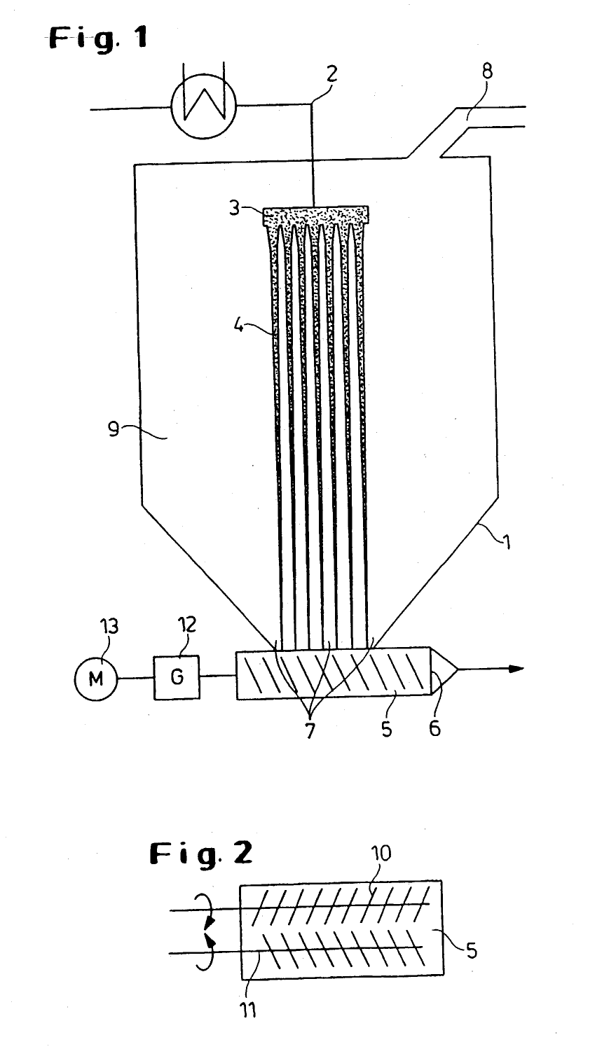

FIG. 1 shows the longitudinal section through an evaporator system 1

FIG. 2 shows, in cross section through the evaporator system 1, the region of the discharge opening in a view from above

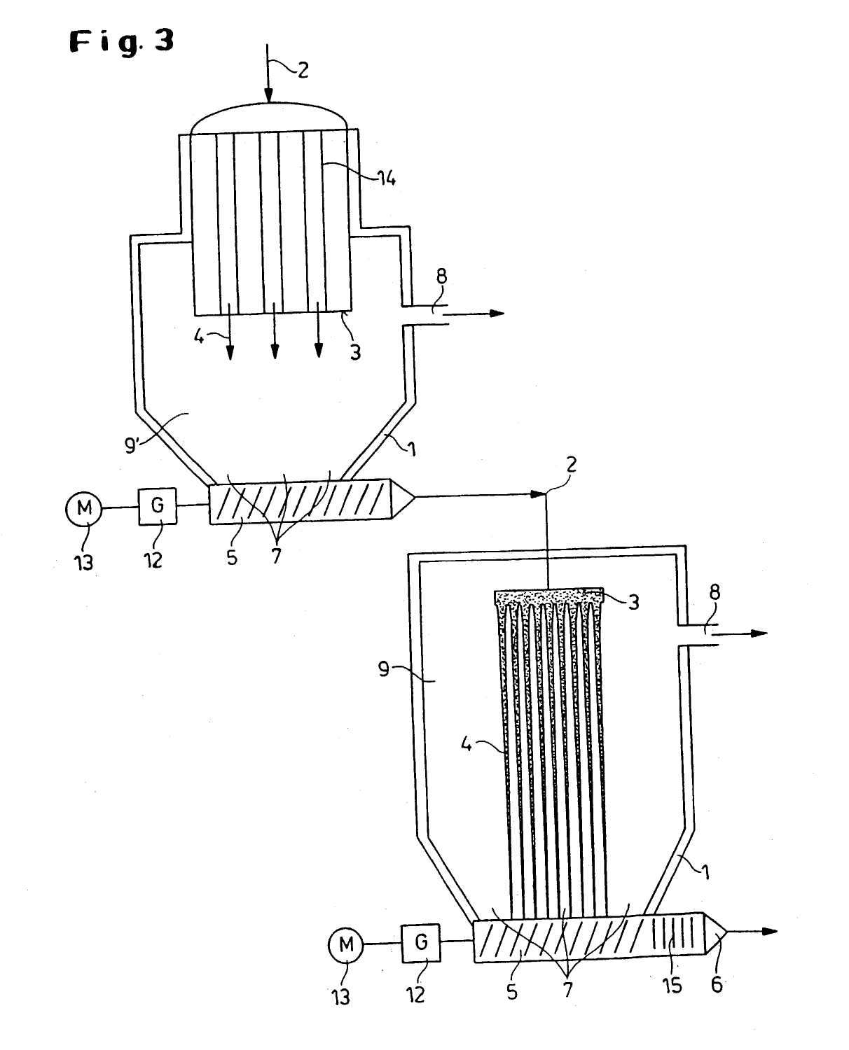

FIG. 3 shows the longitudinal section through an evaporator system 2 composed of two degassing stages following one after the other.

### EXAMPLES

General Process Description of the Examples

The heated or foamed polymer is fed, in a way corresponding to FIG. 1, via a supply line 2 to a distributing device 3 arranged in the degassing vessel 1, where strands 4 are formed, are fed to a twin-shaft discharge screw 5 by the force of gravity and are extruded by the said screw through a die 6. The vapours released are extracted from the degassing space 9 via a vapour line 8. The capture zone 7 (inlet opening) of the discharge screw 5 is designed in such a way that all the strands directly encounter the screw shafts 10 and 11 of the twin-shaft discharge screw (cf. FIG. 2). The screw shafts 10 and 11 are driven by the motor 13 via a simple distributing gear mechanism 12 in such a way that they rotate in opposite directions and draw in the polymer in the nip between the screw shafts 10, 11, without allowing contact with the fixed walls of the degassing vessel 1. Instead of the discharge screw 5, a discharge pump with gearwheels may also be arranged (see Example 1).

In the preferred embodiment according to FIG. 3, the polymer is degassed in two degassing stages following one after the other. In this case, different pressure levels are set in the degassing chambers 9′ and 9. Before entering the first degassing chamber 9′, the necessary heat of evaporation is fed to the polymer solution via a heat exchanger 14. It is preferred for the discharge screw 5 beneath the second degassing chamber to be equipped with a mixing zone 15, which allows the mixing in of additives and colorants.

### Example 1

A styrene-acrylonitrile copolymer is grafted onto polybutadiene by discontinuous polymerization, as described in the German patent application with file reference 1993 1254.0, so that a polymer with a 14% rubber fraction is produced. A solution comprising 53% polymer, 4.7% acrylonitrile, 9.9% styrene and 32.4% methylethyl ketone is obtained. 17.2 kg/h of this solution are heated to 112° C. in a heat exchanger heated by saturated steam at 125° C. The absolute pressure lies at 9 bar (9*10⁵ Pa). Therefore, no evaporation takes place at this stage. In a second heat exchanger, which is heated by saturated stream at 235° C., the evaporation of the volatile components commences. The two-phase mixture of concentrated polymer solution and gas leaves this heat exchanger at a temperature of 178° C. The mixture is introduced via a heated tube 2 with an inside diameter of 15 mm into a vacuum chamber 9, where absolute pressure of 460 mbar prevails. The mixture leaves through two bores of 8 mm diameter into the vacuum space 9. The outlet openings are arranged centrally 40 mm above the gearwheels of a polymer discharge pump with a volumetric delivery of 46.3 cm³ per revolution. The pump has a rectangular inlet opening of 97×61 mm. The concentrated polymer solution is directed onto the gearwheels directly without wall contact. The released gases are extracted from the degassing chamber by a vacuum pump and precipitated in a condenser. 7.5 kg/h of condensate are collected. This gives a polymer concentration of 94% for the concentrated solution.

### Example 2

A styrene-acrylonitrile copolymer is grafted onto polybutadiene by discontinuous polymerization, by a process as described in the laid-open patent application EP 824 122 A1, so that a polymer with a 29.2% rubber fraction is produced. A solution comprising 38% polymer, 7.5% acrylonitrile, 13.6% styrene, 27.5% acetone and 12.5% ethylbenzene is obtained. The solution is continuously evaporated to a 99% polymer content in two successive evaporating stages, which are constructed and operated in a way similar to the apparatus in Example 1 (FIG. 3 shows the second stage with the chamber 9′). The polymer preconcentrated in this way is fed at 5.66 kg/h and at a temperature of 267° C. to a strand distributor 3 with four slits with dimensions of 15×1 mm. The polymer passes from the slits into a vacuum chamber 9, which is operated under a pressure of 0.8 mbar (0.8 hPa). After falling for a distance of 1 m, the polymer strips leaving the slits encounter the shafts 10, 11 of a twin-shaft screw 5 rotating in opposite directions. The screw shafts 10, 11 have a diameter of 32 mm and four screw flights with a pitch of 60 mm. The capture zone 7 of the screw 5 has a length of 200 mm. Following the capture zone 7 there is a closed region of 100 mm in length, in which the pressure for the extrusion of the polymer through a die with a diameter of 6 mm is built up. The extruded strand is cooled in a water bath and subsequently pelletized. A residual content of 390 ppm styrene, 780 ppm ethylbenzene and 4 pmm acrylonitrile is found in the pellets.

### Comparative Example

The same procedure as in Example 2 is followed, but the distribution of the strand takes place in a prior-art degassing vessel with a conical outlet and a flanged-on gear pump of the Vacorex type from the company Maag, Zurich, CH. The flow properties of the product cause the polymer to build up in the outlet cone of the degassing vessel. A continuous throughput of the polymer cannot be maintained.

1. Process for the removal of volatile constituents, in particular solvents, monomers or oligomers, from polymer compositions or polymer solutions by evaporating the volatile components from the preheated polymer compositions in the form off free-falling films, strands or foaming liquids in an evaporator system (1), characterized in that, following partial or complete degassing of the volatile components in the degassing space (9) of the evaporator system (1), the degassed polymer composition is received at the lower end of the evaporator system (1) directly by a discharge delivery device and is discharged, thereby avoiding contact of the polymer with the inside wall of the evaporator system (1).

2. Process according to claim 1, characterized in that the discharge delivery device is a screw conveyor (5).

3. Process according to either of claims 1 and 2, characterized in that the degassing of the polymer composition takes place in two, three or more stages, the polymer separated completely or partially from volatile components in the degassing space (9) being taken up directly by the discharge delivery device in every stage.

4. Process according to one of claims 1 to 3, characterized in that polymer compositions or solutions which assume a non-flowable state after the separation of the volatile components are processed.

5. Process according to one of claims 1 to 4, characterized in that thermoplastic polymers, rubber or rubber-modified thermoplastics, in particular polycarbonate, polystyrene, polyphenylene sulphide, polyurethane, polyamide, polyester, polyacrylate, polymethylmethacrylate, SAN resin, ABS, EPDM rubber, polybutadiene or possible mixtures of the polymers are used as polymers.

6. Process according to one of claims 1 to 5, characterized in that additives or dyes, pigments or stabilizers are admixed with the polymer compositions or solutions directly following the degassing, in particular complete degassing, in a mixing zone (15).

7. Apparatus for discharging highly viscous polymer compositions from evaporator systems (1), in particular strand evaporators, tube evaporators or lamellar evaporators, for the removal of volatile compounds from the polymer compositions in the form of free-falling films, strands or foams, comprising at least one single-shaft or multi-shaft, in particular twin-shaft, screw delivery device (5), which is arranged at the lower end of the evaporator system (1), characterized in that the inlet opening (7) of the screw delivery device (5) is arranged beneath the distributor for the polymer composition, the cross section of the inlet opening (7) being greater than the cross section of the polymer composition flowing down.

8. Apparatus according to claim 7, characterized in that a twin-shaft screw delivery device (5) is provided as the discharge device, with a drive means (12) for the mutual rotation of the screw shafts, the screws conveying inwards in the region of the inlet opening (7).

9. Apparatus according to either of claims 7 and 8, characterized in that the pitch of the screw flights (10) of the screw shafts (11) is greater than or equal to the diameter of the screw shaft (11) in the region of the inlet opening (7).

10. Apparatus according to one of claims 7 to 9, characterized in that the profile of the screw shafts (11) in the case of a twin-shaft or multi-shaft arrangement is freely intermeshing in the region of the inlet opening (7) and closely intermeshing in the extrusion zone.

11. Apparatus according to one of claims 7 to 10, characterized in that, on the screw delivery device (5), a mixing zone (15) adjoins the inlet opening (7) and has an additional inlet for solid material or liquid.

12. Apparatus for discharging highly viscous polymer compositions from evaporator systems (1) according to one of claims 7 to 11, characterized in that a roll mill which takes up the concentrated polymer and feeds it through the roll nip to a single-shaft or twin-shaft screw is provided as the discharge device.
